(19) United States
(12) Patent Application Publication
(10) Pub. No.: US 2018/0286620 A1
(43) Pub. Date: Oct. 4, 2018

(54) LOW VOLTAGE CIRCUIT BREAKER

(71) Applicant: ABB Schweiz AG, Baden (CH)

(72) Inventors: Thomas Schmoelzer, Essen (DE); Markus Hoidis, Niederrohrdorf (CH); Enrico Dell Oro, Milano (MI) (IT); Chiara Cantini, Albino (BG) (IT); Antonello Antoniazzi, Milano (MI) (IT); Reinhard Simon, Baden-Daettwil (CH)

(21) Appl. No.: 15/937,011

(22) Filed: Mar. 27, 2018

(30) Foreign Application Priority Data
Mar. 27, 2017 (LU) LU100148

(51) Int. Cl. H01H 71/66; H01H 3/22; H01H 1/021; H01H 73/04; H01H 71/02

(52) U.S. Cl. CPC H01H 71/66; H01H 3/22; H01H 2071/046; H01H 73/04; H01H 71/0264; H01H 1/021

(57) ABSTRACT

A low voltage circuit breaker is provided. The low voltage circuit breaker includes a contact system with a first contact and a second contact that are electrically connectable and disconnectable relative to one another. The first contact includes a body having a first layer and a second layer, wherein the first layer is arranged on the second layer and is configured to come in contact with the second contact for providing the electrical connection with the second contact. The first layer has a first material composition having an Ag content that is higher than an Ag content of a second material composition of the second layer. Further, the first material composition has a WC content that is lower than a WC content of the second material composition.

### FIELD

The present application relates to a low voltage circuit breaker, and specifically to a low voltage circuit breaker having a bi-layered moving contact.

### BACKGROUND

Low voltage circuit breakers are common in domestic, commercial and industrial applications. A low voltage circuit breaker can be an automatically operated electrical switch, specifically designed and configured to protect an electrical circuit from damage caused by excess current, typically resulting from an overload or short circuit. Its basic function is to interrupt current flow after a fault is detected. Unlike a fuse, which operates once and then must be replaced, a circuit breaker can be reset (either manually or automatically) to resume normal operation.

A low voltage circuit breaker normally includes a contact system having two contacts that are electrically connectable and disconnectable relative to one another. Contacts, particularly the moving contacts, in low voltage circuit breakers are normally made of an AgWC material that includes, in mass-%, an Ag content of 60% and a WC content of 40%. The high Ag content provides a low contact resistance and a good oxidation resistance. However, Ag is an expensive material, has a low resistance against arc erosion and is relatively weak, particularly when compared to WC. Therefore, conventional contacts for low voltage circuit breakers are cost intensive to manufacture and have only a reduced life time.

### SUMMARY

The above-mentioned shortcomings, disadvantages and problems are addressed herein which will be understood by reading and understanding the following specification. Specifically, the present disclosure outlines a cost efficient and reliable contact for a low voltage circuit breaker.

According to an aspect, a low voltage circuit breaker is provided. The low voltage circuit breaker includes a contact system with a first contact and a second contact that are electrically connectable and disconnectable relative to one another. The first contact includes a body having a first layer and a second layer, wherein the first layer is arranged on the second layer and is configured to come in contact with the second contact for providing the electrical connection with the second contact. The first layer has a first material composition having an Ag content that is higher than an Ag content of a second material composition of the second layer. Further, the first material composition has a WC content that is lower than a WC content of the second material composition.

According to embodiments, the first layer can have a WC/Ag ratio of equal to or smaller than 80/20, specifically equal to or smaller than 50/50, particularly equal to or smaller than 40/60. Alternatively or additionally, the second layer can have a WC/Ag ratio of equal to or greater than 20/80, specifically equal to or greater than 50/50, particularly equal to or greater than 60/40.

According to embodiments, the first material composition can include, in mass-%, Ag: 30 to 80, W: 25 to 65, Ni: 0 to 40, Co: 0 to 40, Cu: 0 to 40, C: 1.5 to 5, Cr: 0 to 20, Mo 0 to 20, the balance being Fe and inevitable impurities, wherein Ag, W, Ni, Co, Cu, C, Cr and Mo are included in a total amount of at least 80%. According to embodiments, the first material composition can include, in mass-%, Cu: 0 to 20. Specifically, the first material composition can include, in mass-%, Ag: 40 to 65, W: 30 to 50, Ni: 0 to 10, Co: 0 to 10, Cu: 0 to 5, C: 2 to 3.5, the balance being Fe and inevitable impurities, wherein Ag, W, Ni, Co, Cu and C are included in a total amount of at least 96%.

According to embodiments, the second material composition can include, in mass-%, Ag: 20 to 70, W: 35 to 75, Ni: 0 to 40, Co: 0 to 40, Cu: 0 to 40, C: 2 to 5.5, Cr: 0 to 20, Mo 0 to 20, the balance being Fe and inevitable impurities, wherein Ag, W, Ni, Co, Cu, C, Cr and Mo are included in a total amount of at least 80%. According to embodiments, the second material composition can include, in mass-%, Cu: 0 to 20. Specifically, the second material composition can include, in mass-%, Ag: 35 to 75, W: 40 to 60, Ni: 0 to 10, Co: 0 to 10, Cu: 0 to 5, C: 2.5 to 4.5, the balance being Fe and inevitable impurities, wherein Ag, W, Ni, Co, Cu and C are included in a total amount of at least 96%.

According to embodiments, the first layer can have a first conductivity that is higher than a second conductivity of the second layer. In particular, first conductivity can be equal to or greater than 10 MS/m, specifically equal to or greater than 15 MS/m and/or equal to or smaller than 35 MS/m, specifically equal to or smaller than 20 MS/m. Alternatively or additionally, the second conductivity can be equal to or greater than 5 MS/m, specifically equal to or greater than 8 MS/m and/or equal to or smaller than 30 MS/m, specifically equal to or smaller than 20 MS/m.

According to embodiments, the first layer can have a first hardness that is smaller than a second hardness. The first hardness and the second hardness can be determined and/or measured by the Vickers HV1 hardness testing method according to Standard ISO 6507-1. In particular, the first hardness can be equal to or greater than 130 HV1 and/or equal to or smaller than 200 HV1. Alternatively or additionally, the second hardness can be equal to or greater than 150 HV1, specifically equal to or greater than 180 HV1 and/or equal to or smaller than 600 HV1, specifically equal to or smaller than 500 HV1.

According to embodiments, the first layer can have a first thickness being equal to or greater than 3% of a body thickness of the body, specifically equal to or greater than 10% of the body thickness and/or equal to or smaller than 75% of the body thickness.

According to embodiments, the first layer and the second layer can make up at least 80 mass-% of the body.

According to embodiments, the body further can include a transition zone between the first layer and the second layer. An Ag content of the transition zone can be gradually changed from the Ag content of the first layer to the Ag content of the second layer. Alternatively or additionally, a WC content of the transition zone can be gradually changed from the WC content of the first layer to the WC content of the second layer.

According to embodiments, a rated number of switching operations of the low voltage circuit breaker at a rated nominal current can be equal to or smaller than 20000. In particular, a rated number of switching operations of the low voltage circuit breaker at a rated nominal current can be up to 20000.

According to embodiments, the low voltage circuit breaker can be rated for a rated voltage of equal to or greater than 100 V, and/or equal to or smaller than 1200 V, specifically equal to or smaller than 690 V.

According to embodiments, the low voltage circuit breaker can be rated for a current of equal to or greater than 10 A, specifically equal to or greater than 16 A and/or equal to or smaller than 12000 A, specifically equal to or smaller than 6300 A.

According to embodiments, the low voltage circuit breaker can be rated for a short circuit current of equal to or greater than 0.4 kA, specifically equal to or greater than 1 kA and/or equal to or smaller than 400 kA, specifically equal to or smaller than 200 kA.

According to embodiments, the second contact can have a third conductivity being higher than a common conductivity of the body of the first contact. Alternatively or additionally, the second contact can have a third hardness being lower than a common hardness of the body of the first contact.

According to embodiments, the first contact can be attached to a carrier. Further, the carrier can be configured to be rotated about an axis, e.g. for selectively providing and breaking an electrical connection with the second contact. Accordingly, the first contact can be configured to be rotated about an axis, e.g. for selectively providing and breaking an electrical connection with the second contact.

According to embodiments, wherein the first layer and the second layer can be formed by a powder metallurgical process such as sintering.

Embodiments are also directed at apparatuses for carrying out the disclosed methods and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods for operating the described apparatus include method aspects for carrying out functions of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of a low voltage circuit breaker in a disconnected state;

FIG. 2 shows a schematic view of a low voltage circuit breaker in a connected state;

FIG. 3 shows a schematic view of a first contact of a low voltage circuit breaker;

FIG. 4 shows a schematic view of a first contact of a low voltage circuit breaker;

FIG. 5 shows a graph illustrating a dependence of a conductivity on a WC content; and

FIG. 6 shows a graph illustrating a dependence of a hardness on a WC content.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Typically, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations. Unless otherwise stated herein, a percentage for a specific element in a chemical composition shall refer to a mass percentage of that element in the chemical composition.

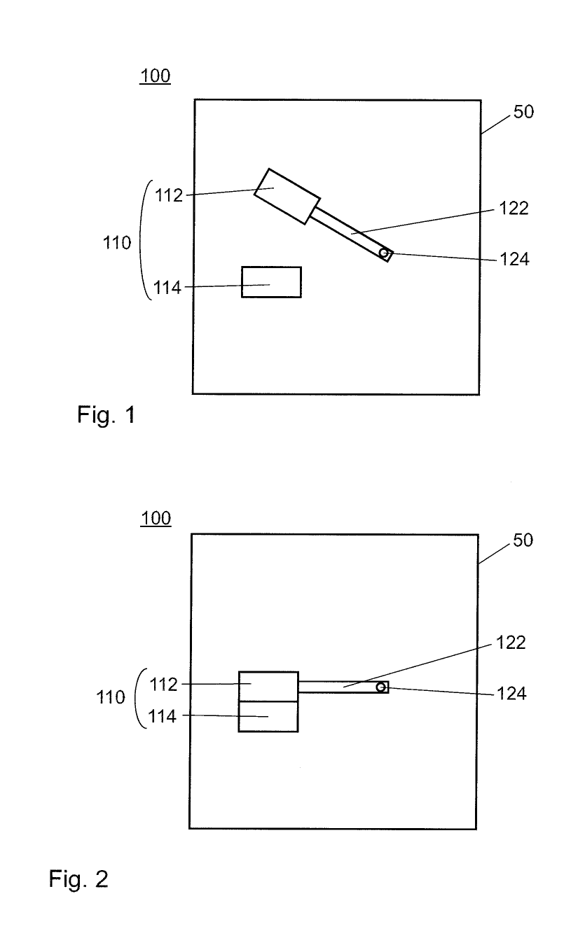

FIGS. 1 and 2 show a low voltage circuit breaker 100. The low voltage circuit breaker 100 can be an automatically operated electrical switch, specifically designed and configured to protect an electrical circuit from damage caused by excess current, typically resulting from an overload or short circuit. Its basic function is to interrupt current flow after a fault is detected. Unlike a fuse, which operates once and then must be replaced, a circuit breaker can be reset (either manually or automatically) to resume normal operation. According to embodiments herein, the low voltage circuit breaker 100 can be configured for a rated number of switching operations at a rated nominal current of equal to or smaller than 20000. In particular, a rated number of switching operations of the low voltage circuit breaker at a rated nominal current can up to 20000. That is, the low voltage circuit breaker 100 can be rated for about 20000 switching operations.

In the context of the present disclosure, “low voltage” can be understood as being equal to or smaller than about 1200 V. According to embodiments described herein, the low voltage circuit breaker 100 can be rated for a rated voltage of equal to or greater than 100 V, and/or equal to or smaller than 1200 V, specifically equal to or smaller than 690 V. Additionally or alternatively, the low voltage circuit breaker 100 can be rated for a rated current of equal to or greater than 10 A, specifically equal to or greater than 16 A and/or equal to or smaller than 12000 A, specifically equal to or smaller than 6300 A. Additionally or alternatively, the low voltage circuit breaker 100 can be rated for a rated short circuit current of equal to or greater than 0.4 kA, specifically equal to or greater than 1 kA and/or equal to or smaller than 400 kA, specifically equal to or smaller than 200 kA.

The low voltage circuit breaker 100 can include a contact system 110. The contact system 110 can have a first contact 112 and/or a second contact 114. The first contact 112 and the second contact 114 can be electrically connectable and disconnectable relative to one another. Accordingly, the first contact 112 and the second contact 114 can be moved from a disconnected state as shown in FIG. 1 to a connected state as shown in FIG. 2. In the disconnected state, the first contact 112 and the second contact 114 are disconnected from each other and no electrical contact is formed between the first contact 112 and the second contact 114. In the connected state, the first contact 112 and the second contact 114 are connected and an electrical contact is formed between the first contact 112 and the second contact 114. Specifically, at least the first contact 112 can be movable for selectively providing and breaking the electrical connection with the second contact 114.

The first contact 112 can include a body b. The body b can have a first layer 11 and/or a second layer 12. The first layer 11 can be arranged on the second layer 12. Further, the first layer 11 can be configured to come in contact with the second contact 114 for providing an electrical connection with the second contact 114.

The first layer 11 can have a first material composition. The second layer 12 can have a second material composition. The first material composition can have an Ag content that is higher than an Ag content of the second material composition. Further, the first material composition can have a WC (tungsten carbide) content that is lower than a WC content of the second material composition.

As discussed herein, conventional contacts in low voltage circuit breakers are normally made of an AgWC material that includes, in mass-%, an Ag content of 60% and a WC content of 40%. The high Ag content provides a low contact resistance and a good oxidation resistance. However, Ag is an expensive material, exhibits low resistance against arc erosion and is relatively weak, particularly when compared to WC.

The present disclosure thus provides for the first layer 11, which is configured to come in contact with the second contact 114, a higher Ag content and a lower WC content as for the second layer 12. When practicing embodiments, a low contact resistance and a good oxidation resistance can be achieved, particularly at an interface with the second contact, while material cost can be saved.

Further, the second layer 12 can be provide an improved erosion resistance as compared to the conventional contact. When practicing embodiments, short circuit behavior of the low-voltage circuit breaker can be improved.

According to embodiments described herein, the first layer 11 can have a WC/Ag ratio of equal to or smaller than 80/20, specifically equal to or smaller than 50/50, particularly equal to or smaller than 40/60. Alternatively or additionally, the second layer 12 can have a WC/Ag ratio of equal to or greater than 20/80, specifically equal to or greater than 50/50, particularly equal to or greater than 60/40.

According to embodiments described herein, the first material composition can include, in mass-%, Ag: 30 to 80, W: 25 to 65, Ni: 0 to 40, Co: 0 to 40, Cu: 0 to 40, C: 1.5 to 5, Cr: 0 to 20, Mo 0 to 20, the balance being Fe and inevitable impurities, wherein Ag, W, Ni, Co, Cu, C, Cr and Mo are included in a total amount of at least 80%. According to embodiments described herein, the first material composition can include, in mass-%, Cu: 0 to 20. Specifically, the first material composition can include, in mass-%, Ag: 40 to 65, W: 30 to 50, Ni: 0 to 10, Co: 0 to 10, Cu: 0 to 5, C: 2 to 3.5, the balance being Fe and inevitable impurities, wherein Ag, W, Ni, Co, Cu and C are included in a total amount of at least 96%.

According to embodiments described herein, the second material composition can include, in mass-%, Ag: 20 to 70, W: 35 to 75, Ni: 0 to 40, Co: 0 to 40, Cu: 0 to 40, C: 2 to 5.5, Cr: 0 to 20, Mo 0 to 20, the balance being Fe and inevitable impurities, wherein Ag, W, Ni, Co, Cu, C, Cr and Mo are included in a total amount of at least 80%. According to embodiments described herein, the second material composition can include, in mass-%, Cu: 0 to 20. Specifically, the second material composition can include, in mass-%, Ag: 35 to 75, W: 40 to 60, Ni: 0 to 10, Co: 0 to 10, Cu: 0 to 5, C: 2.5 to 4.5, the balance being Fe and inevitable impurities, wherein Ag, W, Ni, Co, Cu and C are included in a total amount of at least 96%.

According to particular embodiments, substantially the whole C content and W content of the first material composition and the second material composition can be formed as WC (tungsten carbide). Accordingly, the amounts of C and W in the first material composition and the second material composition can correspond each other in a 1:1 relationship on a level of the individual atoms. As W has a higher molecular weight as C, the mass-% in the respective material compositions is higher for W than for C (about 15.3 times higher).

Taking the above considerations into account, the first material composition can include, in mass-%, Ag: 30 to 80, WC: 26.5 to 70, Ni: 0 to 40, Co: 0 to 40, Cu: 0 to 40, Cr: 0 to 20, Mo 0 to 20, the balance being Fe and inevitable impurities, wherein Ag, W, Ni, Co, Cu, C, Cr and Mo are included in a total amount of at least 80%. According to embodiments described herein, the first material composition can include, in mass-%, Cu: 0 to 20. Specifically, the first material composition can include, in mass-%, Ag: 40 to 65, W: 32 to 53.5, Ni: 0 to 10, Co: 0 to 10, Cu: 0 to 5, the balance being Fe and inevitable impurities, wherein Ag, W, Ni, Co, Cu and C are included in a total amount of at least 96%.

Further, the second material composition can include, in mass-%, Ag: 20 to 70, W: 37 to 80.5, Ni: 0 to 40, Co: 0 to 40, Cu: 0 to 40, Cr: 0 to 20, Mo 0 to 20, the balance being Fe and inevitable impurities, wherein Ag, W, Ni, Co, Cu, C, Cr and Mo are included in a total amount of at least 80%. According to embodiments described herein, the second material composition can include, in mass-%, Cu: 0 to 20. Specifically, the second material composition can include, in mass-%, Ag: 35 to 75, W: 42.5 to 64.5, Ni: 0 to 10, Co: 0 to 10, Cu: 0 to 5, the balance being Fe and inevitable impurities, wherein Ag, W, Ni, Co, Cu and C are included in a total amount of at least 96%.

As shown in FIGS. 1 and 2, the low voltage circuit breaker 100 can include a housing 50. The housing 50 can be configured for housing elements of the low voltage circuit breaker 100, such as the first contact 112 and the second contact 114. Further, the low voltage circuit breaker 100 can include mechanism to bias the first contact 112 when in the connected state. By biasing the first contact 112 when in connected state, the first contact 112 can be removed reliably and with high speed in a controlled manner from the second contact 114 upon release of the first contact 112.

According to embodiments described herein, wherein the first contact 112 can be attached to a carrier 122. The carrier 122 can be configured to be rotated about an axis. For instance, the first contact 112 can be attached to the carrier 122 at a first end of the carrier 122. The carrier 122 can be connected at the second end opposite to the first end to a hinge 124. The hinge 124 can be connected to the axis for rotating the carrier 122 around the axis.

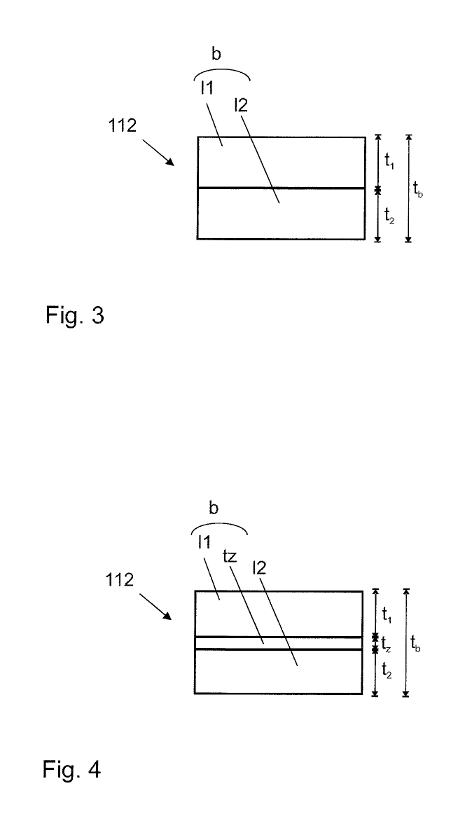

FIG. 3 shows the first contact 112 in more detail. The body b can have a body thickness t_{b}. The first layer 11 can have a first thickness t₁. The second layer 12 can have a second thickness t₂. According to embodiments described herein, the first thickness t₁ can be equal to or greater than 3% of the body thickness t_{b}, specifically equal to or greater than 10% of the body thickness t_{b} and/or being equal to or smaller than 75% of the body thickness t_{b}.

According to embodiments, the first layer 11 and the second layer make up at least 80 mass-% of the body b. In particular embodiments, the first layer 11 and the second layer 12 make up substantially the whole body b. In the latter case, the difference between the body thickness t_{b} and the first thickness t₁ can be the second thickness t₂. In cases where the first layer 11 and the second layer 12 do not make up the whole body b, the sum of the first thickness t₁ and the second thickness t₂ can be smaller than the body thickness t_{b}.

As shown in FIG. 4, the body b can further include a transition zone tz between the first layer 11 and the second layer 12. An Ag content of the transition zone tz can be gradually changed from the Ag content of the first layer 11 to the Ag content of the second layer 12. Alternatively or additionally, a WC content of the transition zone tz can be gradually changed from the WC content of the first layer 11 to the WC content of the second layer 12. The transition zone tz can make up of at least 5%, specifically at least 10%, particularly at least 25% of the sum of the first thickness t₁ and the second thickness t₂.

According to embodiments described herein, the transition zone tz can make up substantially the whole first layer 11 and the second layer 12. Accordingly, in this case, the first layer 11 and the second layer 12 can be considered as sub-layers of the transition zone tz that undergo a gradual change of the Ag content and the WC content from a beginning of the first layer 11 to an end of the second layer 12.

Furthermore, also not explicitly shown in the figures, a top layer can be formed on the first layer 11. The top layer can have an even higher Ag content as the first layer 11. When practicing embodiments, a contact resistance at a surface of the first contact 112 can be further decreased.

According to embodiments described, the body b can essentially consist of the first layer 11, the second layer 12 and optionally the transition zone tz. The term “essentially consist of” can be understood in this context as meaning that no further layer is added intentionally to the body b. However, layers that are added to the body due to constraints of the manufacturing process can also be encompassed by this term.

According to embodiments described therein, the first layer 11 and/or the second layer 12, and/or optionally the transition zone tz, can be formed by a powder metallurgical process such as sintering.

FIG. 5 shows a graph illustrating a dependence of a conductivity on a WC content.

According to embodiments described herein, the first layer 11 can have a first conductivity σ₁. The second layer 12 can have a second conductivity σ₂. The first conductivity σ₁ can be higher than second conductivity σ₂. Specifically, the first conductivity σ₁ can be equal to or greater than 10 MS/m, specifically equal to or greater than 15 MS/m and/or equal to or smaller than 35 MS/m, specifically equal to or smaller than 20 MS/m. Alternatively or additionally, the second conductivity σ₂ can be equal to or greater than 5 MS/m, specifically equal to or greater than 8 MS/m and/or equal to or smaller than 30 MS/m, specifically equal to or smaller than 20 MS/m.

The first conductivity σ₁ can depend on the WC content of the first material composition and/or the second conductivity σ₂ can depend on the WC content of the second material composition. In particular, the first conductivity σ₁ can depend on the WC content of the first material composition in an inverse manner and/or the second conductivity σ₂ can depend on the WC content of the second material composition in an inverse manner. That is, the higher the WC content in the first material composition and/or the second material composition is, the lower the first conductivity σ₁ and the second conductivity σ₂, respectively, can get.

As illustrated in FIG. 5, the dependence of first conductivity σ₁ and/or the second conductivity σ₂ on the WC content of the first material composition and the second material composition, respectively, can be described by the following formulas (1) and (2):

σ₁,σ₂≥(−0.54×WC content)MS/m·mass-%+37 MS/m (1);

and

σ₁,σ₂≤(−0.54×WC content)MS/m·mass-%+60 MS/m (2).

According to embodiments described herein, the second contact 114 can have a third conductivity σ₃ being higher than a common conductivity σ_{b} of the body b of the first contact 112. The common conductivity σ_{b} of the body b can be the overall conductivity of the body b. In the case where the body includes only the first layer 11 and the second layer 12 the common conductivity σ_{b}of the body b can be a mean value of the first conductivity σ₁ and the second conductivity σ₂.

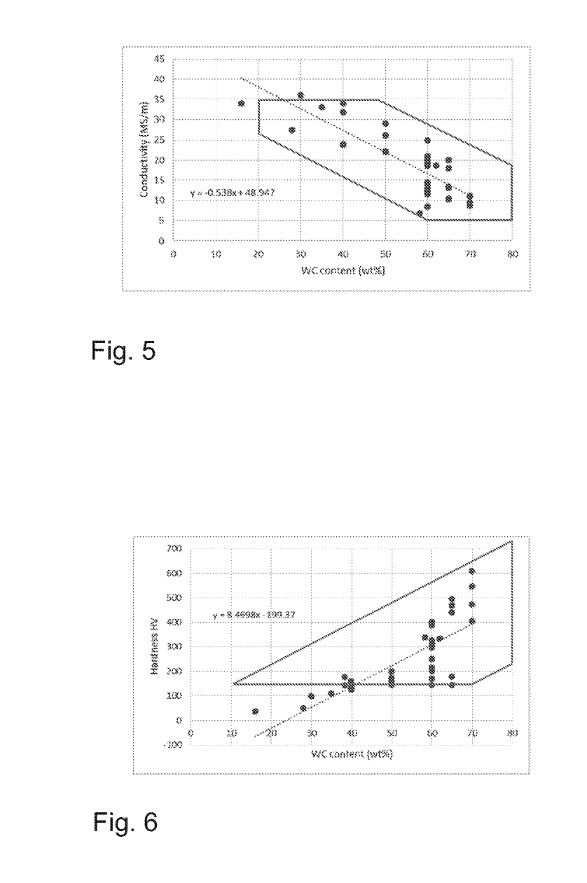

FIG. 6 shows a graph illustrating a dependence of a hardness on a WC content. A hardness referred to herein can be determined and/or measured by the Vickers HV1 hardness testing method according to Standard ISO 6507-1. Accordingly, all values of hardness described herein can be values determined and/or measured by the Vickers HV1 hardness testing method according to Standard ISO 6507-1.

According to embodiments described herein, the first layer 11 can have a first hardness H₁. The second layer 12 can have a second hardness H₂. The first hardness H₁ can be smaller than the second hardness H₂. Specifically, the first hardness H₁ can be equal to or greater than 130 HV1 and/or equal to or smaller than 200 HV1. Alternatively or additionally, the second hardness H₂ can be equal to or greater than 150 HV1, specifically equal to or greater than 180 HV1 and/or equal to or smaller than 600 HV1, specifically equal to or smaller than 500 HV1.

The first hardness H₁ can depend on the WC content of the first material composition and/or the second hardness H₂ can depend on the WC content of the second material composition. In particular, the first hardness H₁ can depend on the WC content of the first material composition in a proportional manner and/or the second hardness H₂ can depend on the WC content of the second material composition in a proportional manner. That is, the higher the WC content in the first material composition and/or the second material composition is, the higher the first hardness H₁ and the second hardness H ₂, respectively, can get.

As illustrated in FIG. 6, the dependence of first hardness H₁ and/or the second hardness H₂ on the WC content of the first material composition and the second material composition, respectively, can be described by the following formulas (3) and (4):

H₁,H₂≥(8.5 ×WC content)HV1/mass-%−350HV1 (3);

and

H₁,H₂≤(8.5 ×WC content)HV1/mass-%+50 HV1 (4).

According to embodiments described herein, the second contact 114 can have a third hardness H₃ being lower than a common hardness H_{b} of the body b of the first contact 112. The common hardness H_{b} of the body b can be the overall hardness of the body b. In the case where the body includes only the first layer 11 and the second layer 12 the common hardness H_{b} of the body b can be a mean value of the first hardness H₁ and the second hardness H₂. Further, also the third hardness H₃ can depend on a WC content of a third material composition of the second contact 114 in the manner as described for the first hardness H₁ and/or the second hardness H₂.

A comparative example may have a first contact that is made of an AgWC material having an Ag content of 60 mass-%. The first contact element of the comparative example may have a weight of about 0.7 g. Accordingly, the first contact element of the comparative example can have a Ag content having a mass of 0.42 g. The first contact of the comparative example can have a volume of about 0.0558 cm³.

An example according to the present disclosure may have a first contact 112 including layer 11 having a Ag content of 60 mass-% and a WC content of 40 mass-% and a second layer 12 having a Ag content of 40 mass-% and a WC content of 60 mass-%. The first layer 11 and the second layer 12 can have the same thickness, i.e. t₁=t₂. Further the first contact 112 according to the example can have the same volume as the first contact of the comparative example. Accordingly, in this example, the first layer 11 has an Ag content having a mass of 0.21 g and the second layer 12 has a Ag content having a mass of 0.151 g. That is, the first contact of this example has in total a Ag content having a total mass of 0.361 g, corresponding to save of 14% of mass of a Ag as compared to the comparative example.

1. A low voltage circuit breaker, comprising:
a contact system with a first contact and a second contact that are electrically connectable and disconnectable relative to one another,
wherein the first contact includes a body having a first layer and a second layer, wherein the first layer is arranged on the second layer and is configured to come in contact with the second contact for providing the electrical connection with the second contact,
wherein the first layer has a first material composition having an Ag content that is higher than an Ag content of a second material composition of the second layer, and wherein the first material composition has a WC content that is lower than a WC content of the second material composition.

2. The low voltage circuit breaker according to claim 1, wherein the first material composition includes, in mass-%, Ag: 30 to 80, W: 25 to 65, Ni: 0 to 40, Co: 0 to 40, Cu: 0 to 40, C: 1.5 to 5, Cr: 0 to 20, Mo 0 to 20, the balance being Fe and inevitable impurities, wherein Ag, W, Ni, Co, Cu, C, Cr and Mo are included in a total amount of at least 80%.

3. The low voltage circuit breaker according to claim 1, wherein the second material composition includes, in mass-%, Ag: 20 to 70, W: 35 to 75, Ni: 0 to 40, Co: 0 to 40, Cu: 0 to 40, C: 2 to 5.5, Cr: 0 to 20, Mo 0 to 20, the balance being Fe and inevitable impurities, wherein Ag, W, Ni, Co, Cu, C, Cr and Mo are included in a total amount of at least 80%.

4. The low voltage circuit breaker according to claim 1, wherein the first layer has a first conductivity σ₁ that is higher than a second conductivity σ₂ of the second layer.

5. The low voltage circuit breaker according to claim 4, wherein the first conductivity σ₁ is equal to or greater than 10 MS/m, and/or the second conductivity σ₂ is equal to or greater than 5 MS/m.

6. The low voltage circuit breaker according to claim 1, wherein the first layer has a first hardness H₁ that is smaller than a second hardness H₂ of the second layer.

7. The low voltage circuit breaker according to claim 6, wherein the first hardness H₁ is equal to or greater than 130 HV1 and/or equal to or smaller than 200 HV1, and/or wherein the second hardness H₂ is equal to or greater than 150 HV1.

8. The low voltage circuit breaker according to claim 1, wherein the first layer has a first thickness (t₁) being equal to or greater than 3% of a body thickness (t_{b}) of the body (b),).

9. The low voltage circuit breaker according to claim 1, wherein the first layer and the second layer make up at least 80 mass-% of the body (b).

10. The low voltage circuit breaker according to claim 1, wherein the body further includes a transition zone (tz) between the first layer and the second layer, wherein an Ag content of the transition zone (tz) is gradually changed from the Ag content of the first layer to the Ag content of the second layer and/or wherein a WC content of the transition zone (tz) is gradually changed from the WC content of the first layer to the WC content of the second layer.

11. The low voltage circuit breaker according to claim 1, wherein a rated number of switching operations of the low voltage circuit breaker at a rated nominal current is equal to or smaller than 20000.

12. The low voltage circuit breaker according to claim 1, wherein the low voltage circuit breaker is rated for a voltage of equal to or greater than 100 V, and/or equal to or smaller than 1200 V.

13. The low voltage circuit breaker according to claim 1, wherein the low voltage circuit breaker is rated for a current of equal to or greater than 10 A, specifically equal to or greater than 16 A and/or equal to or smaller than 12000 A, and/or wherein the low voltage circuit breaker is rated for a short circuit current of equal to or greater than 0.4 kA.

14. The low voltage circuit breaker according to claim 1, wherein the first contact is attached to a carrier, wherein the carrier is configured to be rotated about an axis.

15. The low voltage circuit breaker according to claim 1, wherein the first layer and the second layer have properties consistent with being formed by a powder metallurgical process such as sintering.

16. The low voltage circuit breaker according to claim 2, wherein the second material composition includes, in mass-%, Ag: 20 to 70, W: 35 to 75, Ni: 0 to 40, Co: 0 to 40, Cu: 0 to 40, C: 2 to 5.5, Cr: 0 to 20, Mo 0 to 20, the balance being Fe and inevitable impurities, wherein Ag, W, Ni, Co, Cu, C, Cr and Mo are included in a total amount of at least 80%.

17. The low voltage circuit breaker according to claim 4, wherein the first conductivity σ₁is equal to or smaller than 20 MS/m, and/or the second conductivity σ₂ is equal to or smaller than 20 MS/m.

18. The low voltage circuit breaker according to claim 6, wherein the the second hardness H₂ is equal to or greater than 180 HV1 and/or equal to or smaller than 600 HV1.

19. The low voltage circuit breaker according to claim 1, wherein the first layer has a first thickness (t₁) being equal to or greater than 10% of the body thickness (t_{b}) and/or being equal to or smaller than 75% of the body thickness (t_{b}).

20. The low voltage circuit breaker according to claim 2, wherein the first layer has a first conductivity σ₁ that is higher than a second conductivity σ2 of the second layer.
